(19) United States
(12) Patent Application Publication
(10) Pub. No.: US 2009/0041996 A1
(43) Pub. Date: Feb. 12, 2009

(54) Laminate Containing an Electrically Conductive Fabric, Electrothermal Deicer Comprising Same and Part of an Aerodyne Comprising Such a Deicer

(75) Inventor: Loic Boissy, Caudebec Les Elbeuf (FR)

Correspondence Address: CASELLA & HESPOS, 274 MADISON AVENUE, NEW YORK, NY, 10016, US

(73) Assignee: AERAZUR, Issy Les Moulineaux (FR)

(21) Appl. No.: 11/922,992

(22) PCT Filed: Jun. 27, 2006
(86) PCT No.: PCT/FR2006/001494

§ 371 Date: Feb. 15, 2008

(30) Foreign Application Priority Data
Jun. 30, 2005 (FR) 0506729
Dec. 12, 2005 (FR) 0512552

(51) Int. Cl. B32B 7/02; B05D 3/12; B05D 3/02

(52) U.S. Cl. 428/215; 428/221; 427/370; 244/134 E

(57) ABSTRACT

The invention concerns a laminate comprising a conductive fabric web (2) consisting essentially of electrically conductive material fibers, said web is provided with a terminal (2) designed to be connected to an electric current source, being sandwiched between an upper reinforcing layer (3) and a lower reinforcing layer (1) consisting each of an electrically insulating material. Said laminate is characterized in that said upper (3) and lower layers (1) comprise each an elastomer. The invention also concerns an electrothermal deicer comprising said laminate sandwiched between two protective coatings (5, 6), one of said coatings being optionally covered with a metal foil (8).

### BACKGROUND OF THE INVENTION

1. Field of the Invention

The present invention relates to a laminate comprising a conductive fabric web consisting essentially of electrically conductive material fibers, said web which is provided with means designed to be connected to an electric current source, being sandwiched between an upper reinforcing layer and a lower reinforcing layer, consisting each of an electrically insulating material.

2. Description of the Related Art

Laminates of this type are already known in which the upper and lower reinforcing layers consist each of a glass fiber fabric associated with an epoxy resin, for example impregnated with such a resin.

However, these laminates have the disadvantage of not being deformable.

Under these conditions, it is not possible, from a plane laminate, to produce a laminate with a complex shape in three dimensions.

Thus, this requires the manufacture of laminates directly having the desired shape, which is very difficult from a technical point of view, and expensive.

Moreover, these same laminates have a low resistance to mechanical stressing, such as vibrations for example.

### SUMMARY OF THE INVENTION

The object of the present invention is to remedy the above-mentioned disadvantages and for that purpose, it provides a laminate as defined in the first paragraph of this disclosure, and which is characterized in that said upper and lower reinforcing layers each comprise an elastomer, preferably in a proportion of at least about 70 weight %.

This elastomer may be a natural or synthetic elastomer.

Preferably, it is selected amongst a neoprene elastomer, a polyurethane elastomer and a nitrile elastomer.

The upper and lower reinforcing layers can both only consist of an elastomer.

Alternatively, at least one of said upper and lower layers further comprises a flexible fabric, which is impregnated with said elastomer or is provided with a coating consisting of said elastomer; in this case, the flexible fabric preferably represents 15% to 30% of the total weight of the fabric and the elastomer.

Advantageously, the flexible fabric provided with said coating comprises polyester fibers, polyamide fibers, polyaramide fibers, glass fibers or a mixture of these fibers.

The reinforcing layers preferably each have, independently, a thickness from 25 to 100 hundredths of mm.

The conductive fabric web advantageously comprises a binder consisting of the drying product of a dissolution of an elastomer in an organic solvent.

In this dissolution, the proportion of the elastomer is preferably comprised in the range of from 20 weight % to 40 weight %; said solvent is preferably a ketone, such as acetone or methylethylketone.

In addition, the proportion of the conductive fabric is advantageously in the range of from 5% to 30% of the total weight of said conductive fabric and said drying product.

In the above-mentioned binder, the elastomer may be selected amongst a neoprene elastomer, a polyurethane elastomer and a nitrile elastomer.

The elastomer used for producing the support layer(s) is preferably of the same type as the elastomer implemented with the conductive fabric.

The fibers of said conductive fabric can for example consist of carbon fibers provided with a nickel coating, these fibers preferably being relatively short, of a length of approximately 10 μm for example; the fabric corresponding to this definition is known under the THERMION® trademark, and is marketed by the American company Thermion Systems International, Inc.

The conductive fabric fibers preferably comprise a coating placed under said binder and consisting of a primer facilitating the anchorage of said dissolution to the fibers, the proportion of this coating being advantageously in the range from 1% to 5% with respect to the total weight of the coating and conductive fabric fibers.

As it may be understood, the laminate according to the invention essentially consists of flexible materials.

Consequently, it can be produced as a plane base, able to undergo shape modifications, with no risk of breaking, to produce complex shapes in three dimensions.

Moreover, given its original structure, this laminate presents, with respect to the prior art laminates, a much better resistance to mechanical stressing, such as vibrations for example.

The laminate according to the invention can be manufactured by the method described hereinafter.

1. A layer of a material intended to form the lower reinforcing layer of the laminate is deposited on an appropriate support.

This material is either an elastomer or the flexible fabric impregnated with said elastomer or provided with a coating of such an elastomer.

In the case of the implementation of a flexible fabric, an elastomer solution in a suitable solvent is coated on this fabric by means of a bath or a brush, or by spraying.

Then, it is dried, at room temperature for example.

Alternatively, a thin elastomer sheet is coated on the side of the flexible fabric intended to come into contact with the conductive fabric, said sheet which, during one of the following operations of the method, is caused to impregnate said flexible fabric.

2. Separately, the primer (dissolved in a solvent) is deposited on a conductive fabric web, one end of which is provided with means designed to be connected to an electric current source.

This deposit can be carried out using a bath, or by brush application or spraying.

It is followed by a drying in order to remove the solvent.

3. On the conductive fabric web whose fibers were coated with the primer as indicated at 2., the dissolution (elastomer dissolved in an organic solvent) is then coated.

This coating is carried out by means of a bath or a brush or by spraying; it is followed by a drying, at room temperature for example, which leaves the binder on the fabric web fibers.

Alternatively, on said web, a sheet of said elastomer is coated, a sheet which during the following part of the method, will impregnate the fabric web and constitute said binder.

4. The conductive fabric web obtained at 3. is then deposited on the lower reinforcing layer obtained at 1.

5. In addition, a layer of a material intended to form the upper reinforcing layer of the laminate is produced as at 1.

6. The layer obtained at 5. is then coated on the conductive fabric web of the assembly obtained at 4.

7. A plate is then applied on the upper layer of the assembly obtained at 6., and the latter is brought to a given temperature, and a determined pressure is exerted onto the plate for a suitable duration (usually from 5 to 10 minutes), advantageously selected to avoid a cooking of the elastomer, which would make it lose its stickiness.

This temperature and this pressure are selected so that there is a flowing of the elastomer, i.e. migration of this one in the various fabrics and, thereby, securing the various layers to each other, to obtain the laminate according to the invention.

Generally, this temperature is approximately 60-140° C., and this pressure of approximately 2.10⁵ to 4.10⁵ Pa.

The following are also in the scope of the present invention:
the use of the above-mentioned laminate for the realization of an electrothermal deicer,
an electrothermal deicer, comprising the above-mentioned laminate, sandwiched between a first protective coating and a second protective coating, both of an elastomer,
a deicer as defined above, further comprising a metal foil covering the external face of one of said protective coatings, this foil being secured by an adhesive to said external face, and
a part of an aerodyne such as a propeller blade, provided with the above-mentioned electrothermal deicer, this one being secured to said portion by the external face of the protective coating not covered with said metal foil.

The above-mentioned protective coatings are in particular made of an elastomer, for example a nitrile elastomer, a neoprene elastomer or a polyurethane elastomer.

The function of these coatings is to protect the deicer against various environmental attacks (impacts, erosion, abrasion, UV, fluids such as oils and fuel, low and high temperatures) and for this purpose, they can contain fillers to better resist this kind of attacks.

These fillers can consist of a fabric (made of kevlar or polyester) or a grid (made of metal or polyester) for example.

of course, if a metal foil is laid down on the external face of the protective coating, these fillers have less importance and can even be useless.

In fact, because of its own properties (hardness, mechanical resistance), this metal foil protects the deicer against impacts and abrasion to which it can be subjected during its use.

The metal foil can be made of any metal having the desired properties, for example of stainless steel or Brightray alloy.

As for its thickness, it is advantageously approximately 0.05 to 0.150 mm.

The metal foil can itself be protected against corrosion, by a coat of paint or a chemical treatment for example.

The metal foil is advantageously secured to the protective coating by using an adhesive, such as a neoprene glue, after the deposit of one or more layers of anchorage primer on the metal foil on its face to be applied on said protective coating.

Thanks to the flexibility of its components, the deicer according to the invention can be easily applied on a support to be protected against frost, for example a propeller blade.

This deicer is made by depositing on a support, in the following order, a lower elastomer protective sheet, a layer of glue, the laminate, a layer of glue and an upper elastomer protective sheet.

A plate is placed onto the upper sheet, a pressure of from 2.10⁵ to 4.10⁵ Pa is applied and the whole is brought to a temperature of 120 to 180° C. for 50 to 70 minutes.

The deicer is then detached from its support, a contact glue is applied to the area to be protected against frost, a propeller blade area for example, intended to receive the deicer, and on the external face of the lower elastomer sheet and the latter is brought in contact with said face.

If a metal foil is provided on the external face of the deicer, it is preferred to start with the assembly of the metal foil and one of the protective sheets, by depositing an anchorage primer on one of the faces of the metal foil and an adhesive on one of the faces of said protective sheet, by applying the face comprising the metal foil primer to the sized face of the protective sheet, then by passing the resulting product in a press.

The realization of the deicer is then continued as indicated above.

### BRIEF DESCRIPTION OF THE DRAWINGS

An embodiment of the present invention is described hereinafter as a non-limiting example, in reference to the annexed drawing wherein:

FIG. 1 is a schematic longitudinal section view of the laminate, and

FIG. 2 is a schematic longitudinal section view of the deicer comprising the laminate of FIG. 1, this deicer being associated with a propeller blade,

being specified that the different layers of the laminate and deicer are each shown separately for a better comprehension.

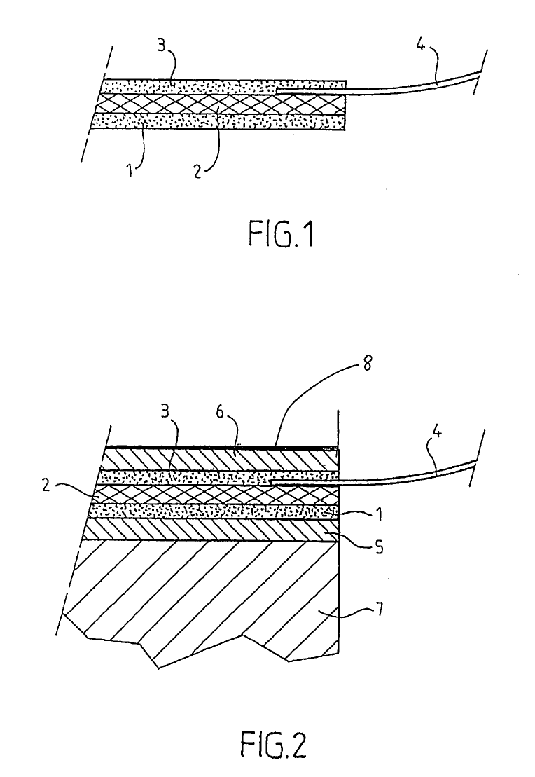

As shown in FIG. 1, the laminate comprises in this order:
a lower elastomer layer 1,
an intermediate layer 2 made of a conductive fabric web (for example THERMION®) impregnated with an elastomer binder, and
an upper layer 3 made of a fabric coated with an elastomer.

Furthermore, two electrical conductors 4 (notably made of copper) are fixed at two points of the upper face of the intermediate layer 2, one end of these conductors projecting from the laminate in view of their connection to the poles of a non-represented electric current source.

### DETAILED DESCRIPTION OF THE PREFERRED EMBODIMENT

As shown in FIG. 2, the above-mentioned laminate is covered on one side with a protective layer 5, and on the other with a protective layer 6, both made of elastomer; the resulting unit constitutes the deicer according to the invention.

According to an alternative, the deicer is supplemented by a metal foil 8 applied on the protective layer 6.

This deicer is then stuck onto the area of the propeller blade 7, requiring the action of a deicer; when the metal foil 8 is present, the deicer is applied on the propeller blade 7, by its protective layer 5.

This metal foil 8 has the following various advantages:
it makes it possible to protect the concerned area, for example the leading edges of a propeller blade, without having to modify the blade itself,
it increases the impact and abrasion resistance of the deicer,
with respect to an area to be protected in which a deicer is integrated, the maintenance costs are lower because it is possible to change the deicer independently of said area to be protected,
when the area to be protected is made of a metal, the deicer provided with the metal foil is aesthetically close to the conventional aspect of said metal area.

1. A laminate comprising a conductive fabric web (2) consisting essentially of electrically conductive material fibers, said web which is provided with means (4) to be connected to an electric current source, being sandwiched between an upper reinforcing layer (3) and a lower reinforcing layer (1) consisting each of an electrically insulating material, characterized in that said upper (3) and lower (1) layers comprise each an elastomer.

2. The laminate according to claim 1, characterized in that said elastomer is selected amongst a neoprene elastomer, a polyurethane elastomer and a nitrile elastomer.

3. The laminate according to claim 1, characterized in that at least one (3) of said upper and lower layers further comprises a flexible fabric, which is impregnated with said elastomer or is provided with a coating consisting of said elastomer.

4. The laminate according to claim 3, characterized in that the proportion of flexible fabric accounts for 15% to 30% of the total weight of the fabric and elastomer.

5. The laminate according to claim 3, characterized in that the flexible fabric provided with said coating comprises polyester fibers, polyamide fibers, polyaramide fibers, glass fibers or a mixture of these fibers.

6. The laminate according to claim 1, characterized in that said reinforcing layers have each, independently, a thickness from 25 to 100 hundredths of a millimeter.

7. The laminate according to claim 1, characterized in that the conductive fabric web (2) further comprises a binder consisting of the drying product of a dissolution of an elastomer in an organic solvent.

8. The laminate according to claim 7, characterized in that the proportion of the elastomer in said dissolution is in the range of from 20 weight % to 40 weight %.

9. The laminate according to claim 7, characterized in that said organic solvent is a ketone, such as acetone or methylethylketone.

10. The laminate according to claim 7, characterized in that the proportion of the conductive fabric is in the range of from 5% to 30% of the total weight of said conductive fabric and said drying product.

11. The laminate according to claim 7, characterized in that the elastomer of said dissolution is selected amongst a neoprene elastomer, a polyurethane elastomer and a nitrile elastomer.

12. The laminate according to claim 7, characterized in that the conductive fabric fibers consist of carbon fibers provided with a nickel coating.

13. The laminate according to claim 7, characterized in that the conductive fabric fibers comprise a coating provided under said binder and consisting of a primer facilitating the anchorage of said dissolution to the fibers.

14. The laminate according to claim 13, characterized in that the proportion of the coating is in the range of from 1% to 5% of the total weight of the coating and conductive fabric fibers.

15. (canceled)

16. An electrothermal deicer, comprising the laminate according to claim 1, sandwiched between a first protective coating (5) and a second protective coating (6), both made of elastomer.

17. The electrothermal deicer according to claim 16, characterized in that it further comprises a metal foil (8) covering the external face of one (6) of the protective coatings (5, 6).

18. The electrothermal deicer according to claim 17, characterized in that said metal foil (8) is secured by an adhesive to said external face.

19. A part of an aerodyne, such as a propeller blade, characterized in that it is provided with the electrothermal deicer according to claim 16, this one being secured by the external face of one (5) of its protective coatings (5, 6) to said part of an aerodyne.

20. A part of an aerodyne, such as a propeller blade, characterized in that it is provided with the electrothermal deicer according to claim 18, this one being secured to said part of an aerodyne by the external face of its protective coating (5) not covered with said metal foil (8).

21. A method for producing a laminate comprising the following steps:
depositing an elastomer layer on two distinct suitable supports so as to form a lower reinforcing layer and an upper reinforcing layer of the laminate,
drying said reinforcing layers,
depositing a primer dissolved in a solvent on a conductive fabric web, of which one end is provided with means to be connected to an external electric current source,
drying the thus covered fabric web to remove the solvent,
applying an elastomer dissolved in an organic solvent on the conductive fabric web whose fibers were covered with the primer,
drying the thus covered web so as to remove the organic solvent and to leave the elastomer on the fabric web fibers,
depositing the conductive fabric web on the lower reinforcing layer,
depositing the upper reinforcing layer on the conductive fabric web,
applying a plate on the upper layer and bringing it to a determined temperature,
exerting a determined pressure on the plate for a suitable duration, so as to create an elastomer flow towards the fabric web fibers, to secure the various layers to each other in order to obtain said laminate.

22. The method according to claim 21, characterized in that the temperature is from 60° C. to 140° C., and the pressure is from 2.10⁵ to 4.10⁵ Pa.
